(19) United States
(12) Patent Application Publication
(10) Pub. No.: US 2003/0110694 A1
(43) Pub. Date: Jun. 19, 2003

(54) Method for oxygen enhanced syngas production

(76) Inventors: Raymond Francis Drnevich, Clarence Center, NY (US); Gary Wayne Fenner, Grand Island, NY (US); Hisashi Kobayashi, Putnam Valley, NY (US); Lawrence E. Bool III, East Aurora, NY (US)

Correspondence Address: PRAXAIR, INC., LAW DEPARTMENT - M1 557, 39 OLD RIDGEBURY ROAD, DANBURY, CT, 06810-5113, US

(21) Appl. No.: 10/024,056

(22) Filed: Dec. 17, 2001

(51) Int. Cl. C01B 3/32

(52) U.S. Cl. 48/198.5; 48/62 R; 48/63; 48/89; 423/650

(57) ABSTRACT

Abstract of the Invention This invention is directed to a process for producing syngas by increasing the flow of a mixture of steam and methane into a steam methane reformer reaction. This process comprises adding an oxygen-enriched gas to the steam to produce an enriched-oxygen/steam mixture prior to mixing the steam with the methane in the reformer reaction. Oxygen-enriched gas may be added directly to the steam-methane mixture, or to the combustion air. Oxygen-enriched gas may also be added to the air-methane mixture of a gas turbine for operation with the steam methane reforming process.

### FIELD OF THE INVENTION

This invention is generally related to a process for producing syngas. More specifically, this invention is related to increasing the production of syngas by the addition of an oxygen-enriched gas.

### BACKGROUND OF THE INVENTION

The production of syngas in a steam methane reformer is an endothermic process driven by heat produced by burning a fuel in the combustion section of the reformer. The rate of syngas formation is generally limited by the rate of heat transfer.

Steam Methane Reformers (SMRs) are used to produce syngas from natural gas. Before entering the SMR, steam is added to natural gas prior to being fed into the reaction zone of the SMR. The SMR reaction is:

CH₄+H₂O←→3 H₂+CO.

Since this reaction is endothermic, the heat required to drive the reaction forward is provided by burning a fuel in the combustion section of the reformer. The shift conversion reaction shown below also takes place in the reformer and establishes the equilibrium between the hydrogen and carbon oxide species in the reformed gas:

CO+H₂O←→H₂+CO₂.

In the prior art, an air stream and a natural gas stream are fed into the radiant zone of the SMR. The natural gas and air streams are combusted in order to provide the heat required for the SMR reaction.

There are several approaches that the industry has taken in order to increase SMR productivity. One approach is to increase the firing rate of the primary reformer. The output is increased by burning more fuel, which raises the average temperature on the combustion side of the reforming system. As a result, more heat is transferred to the reaction zone and more gas can be processed.

Other approaches involve employoing addition of additional processing equipment. These include the addition of a low temperature shift reactor, a pre-reformer, and a post reformer.

The low temperature shift reactor would follow the high temperature shift unit and convert more of the moisture reacting with carbon monoxide to produce hydrogen. However, it does not increase reformer throughput.

In a pre-reformer, adiabatic steam-hydrocarbon reforming is performed on the process gases prior to introducing the process gases into the reformer. Heat for the reforming reactions is obtained by preheating the feed against hot flue gases in the reformer convection section.

There are two types of post reformers: a bypass-feed product-heat-exchange reformer and an oxygen secondary reformer. The bypass-feed product-heat-exchange reformer uses the heat contained in the reformer product gas to provide the heat to drive additional reforming. The feed to this unit is normally a steam-hydrocarbon mixture that bypasses the primary reformer. The oxygen secondary reformer involves adding a steam/oxygen mixture to the output from the primary reformer off-gas and passing the combined mixture through a catalyst bed to convert residual methane to hydrogen and carbon monoxide. Normally, the primary reformer is operated at a higher throughput (greater process gas flow without increasing firing rate). Such an arrangement increases the overall system capacity and provides more methane for conversion in the secondary oxygen unit.

A number of literature references have discussed this subject matter. U.S. Pat. No. 6,217,681 B1 discloses the use of an oxygen rich vent stream as the oxygen source for oxy-fuel combustion or enrichment oxygen in air-fuel combustion to provide heating for primary melting of glass or aluminum. However, there is no teaching or suggestion for the use of the waste oxygen stream in the SMR combustors to enhance hydrogen production.

U.S. Pat. No. 6,200,128 B5 discloses the recovery of heat from a gas turbine exhaust by introducing the exhaust into a combustion device and adding an oxidant having a concentration greater than 21% to form a mixture that has an oxygen content less than 21%. Further, the patent discloses operating the combustion device at conditions substantially equal to those achieved with air combustion of fuel in the combustion device.

Wei Pan et al. (“CO₂ Reforming and Steam Reforming of Methane at Elevated Pressures: A Computational Thermodynamic Study” Proc.—Annu. Int. Pittsburgh Coal Conference, Vol. 16, 1999, pp. 1649-1695) discloses carbon dioxide reforming and the replacement of steam with oxygen in the carbon dioxide reforming process. The calculations therein provide the equilibrium conditions at given input temperatures and pressures. Steam methane reforming is not specifically discussed and no teaching or suggestion as to how this would be implemented.

V. R. Choudhary et al. (“Simultaneous Steam and CO₂ Reforming of Methane to Syngas over NiO/MgO/SA-5205 in the Presence and Absence of Oxygen,” Applied Catalysis A: General,168, (1998), pp. 33-46) discloses the performance of different gas mixtures on methane conversion to syngas based on a −1 ms residence time catalytic reactor. Because of the short residence time, the reaction zone is essentially adiabatic, no significant amount of heat transfer is possible. There is no teaching or suggestion for applying catalyst in conventional furnace based reformer systems.

G. J. Tjatjopoulos et.al. (“Feasibility Analysis of Ternary Feed Mixture of Methane with Oxygen, Steam, and Carbon Dioxide for the Production of Methanol Synthesis Gas,” Industrial and Engineering Chemistry Research, Vol. 37, No.4, 1998-04, pp. 1410-1421) discloses the impact of various mixtures on the thermodynamic equilibrium achieved at the end of the reactor. This reference discloses implementing systems with CH₄/O₂/H₂O mixtures involves a two stage process involving primary and secondary reformers if the ternary mixture is endothermic and a single stage adiabatic unit if the mixture is exothermic.

U.S. Pat. No. 5,752,995 discloses the use of a specific catalyst in reforming reactions including space velocity considerations as well as steam to carbon ratio specifications and the use of oxygen containing gas from a group consisting of steam, air, oxygen, oxides of carbon and mixtures thereof. There is no teaching or suggestion on the addition of oxygen to SMR process feeds to increase the productivity of existing reformers.

EP1 077 198 A2 and EP1 077 198 A3 disclose the addition of a pre-reformer to remove oxygen from the feed to the primary reformer. There is no teaching or suggestion for the addition of oxygen to the primary reformer process feed gas.

Lambert, J. et. al. (“Thermodynamic Efficiency of Steam Methane Reforming with Oxygen Enriched Combustion,” The 5^{th} World Congress of Chemical Engineering: Technologies Critical to the Changing World. Volume III: Emerging Energy Technologies, Clean Technologies, Remediation, and Emission Control; Fuels and Petrochemicals. July 14-18, 1996, San Diego, Calif., Publisher; AIChE, NY, N.Y. pp. 39-44) discloses the use of oxygen-enriched air combustion in combination with steam methane reforming and water gas shift reactions. Lambert et al. discloses improved conversion of methane at constant fuel (furnace firing rates) and process feed gas rates. However, there is no teaching or suggestion as to how this would impact existing reformers.

Relative Performance

| | Baseline-Air- | Prior Art- | Invention- |
|---|---|---|---|
| | 20.3% O₂ | 23.6% O₂ | 23.6% O₂ |
| | wet | wet | wet |
| Total Natural Gas Feed | 1.00 | 1.00 | 1.19 |
| Plus Fuel Rate | | | |
| Reformer Product Rate | 1.00 | 1.09 | 1.25 |
| —H2 Plus CO | | | |

### SUMMARY OF THE INVENTION

This invention utilizes oxygen enhancement to permit the SMR operator to increase the flow of the steam-methane mixture to the reformer, achieve similar compositions in the reformer outlet, and, therefore, increase the reformer productivity. In the preferred embodiment of this invention, oxygen is added to the steam prior to mixing the steam with the natural gas. The oxygen-containing steam is then combined with the natural gas. The combined stream is then fed into the SMR reaction zone. In the reaction zone, partial oxidation occurs due to the presence of oxygen. This reaction is exothermic and provides additional heat to drive the reforming reactions. This additional heat permits the steam natural gas flow to the reformer to be increased, thus, increasing productivity. This increase is accomplished without any significant changes to the reformer equipment, particularly the flue gas processing equipment. Alternatively, the oxygen can be added directly to the steam-natural gas mixture.

Another means to enhance reformer throughput is to add oxygen to the combustion air before feeding it to the SMR combustors. In this embodiment, the air is oxygen-enriched before combining with the natural gas. The combined stream is then sent to the combustors. More fuel is used in the combustor and more steam-methane mixture is added to the reaction (reforming) zone. The useable heat generated by using oxygen increases and more reformed product is produced. The use of oxygen allows the increase in useable heat to occur without increasing flue gas flow rates.

As an alternative to this approach, if a gas turbine is part of, or is added to the SMR, oxygen enrichment of the air entering the combustor can be used to enhance reformer throughput.

Accordingly, this invention is directed to a process for increasing the rate of syngas production by increasing the flow of a mixture of steam and methane into a steam methane reformer, the process comprises adding an oxygen-enriched gas to steam to produce an enriched-oxygen/steam mixture, then mixing methane with the oxygen-enriched/steam mixture and passing the resulting oxygen-enriched/steam/methane mixture into the reformer.

In another embodiment, this invention is directed to a process for increasing the rate of syngas production by increasing the flow of a mixture of steam and methane into a steam methane reformer, the process comprises adding an oxygen-enriched gas to the mixture prior to passing the resulting oxygen-enriched/steam/methane mixture into the reformer.

In yet another embodiment, this invention is directed to increasing the flow of a mixture of steam and methane into a steam methane reformer, the process comprises adding an oxygen-enriched gas to combustion air to combust additional fuel to drive the reforming reaction.

As used herein, oxygen-enriched gas refers to an oxygen containing gas having at least about 21% oxygen by volume on a dry basis. This invention contemplates the use of oxygen-containing gas having at least 21% oxygen by volume on a dry basis up to pure oxygen. Heat generated from the oxidation resulting from the addition of oxygen-enriched gas may be used in the steam/methane mixture to drive the reforming reaction. Adding oxygen-enriched gas to retrofit existing methane reformers is also available. The reformer contains combustion air that is provided in part by the gas turbine exhaust.

### BRIEF DESCRIPTION OF THE DRAWINGS

Other objects, features and advantages will occur to those skilled in the art from the following description of preferred embodiments and the accompanying drawings, in which:

FIG. 1 is a schematic representation of a steam methane reformer system used for the production of hydrogen from natural gas;

FIG. 2 is a partial schematic representation of the system that is directed to the reformer section with an oxygen addition to steam according to the present invention;

FIG. 3 is a graphical representation of the tube wall profile showing the average tube wall temperature against the distance from the entrance of the tube wall according to the present invention;

FIG. 4 is a partial schematic representation of the system that is directed to the reformer section with an oxygen addition to the steam-methane mixture according to the present invention;

FIG. 5 is a partial schematic representation of the system that is directed to the reformer section with an oxygen addition to the combustion air according to the present invention; and

FIG. 6 is a partial schematic representation of the system that is directed to the reformer section with an oxygen addition to the gas turbine hot exhaust gas steam according to the present invention.

### DETAIL DESCRIPTION OF THE INVENTION

The concept of this invention involves adding oxygen either directly to the process gas entering the primary reformer or as a means to enrich the combustion air in quantities that are small enough to prevent a large temperature increases (<400° F. in either the process feed or the adiabatic flame temperature for the oxygen enriched air option) but large enough to enhance the reforming process. The oxygen added to the process gas acts like an oxygen pre-reformer without the addition of a separate reaction vessel. The addition of oxygen in the combustion air acts to drive more heat into the reactor without raising the reactor wall temperature.

The concept of the present invention allows for enhancement in reforming without a loss in efficiency and is a significant advancement over the process that increases the firing rate. Higher firing rates generally result in lower operating efficiency because the temperature and flow of the flue gas leaving the furnace is higher than at normal firing rates and, unless the convective heat recovery section is modified, the stack temperature will be higher than under the original operating mode. The present invention has a higher thermal efficiency than the increased firing rate case because:

1) all of the heat produced through reacting the oxygen with the process gas will be used directly in the reforming process in the case where oxygen is added to the process gas entering the reformer; and

2) the flow of combustion gases through the reformer and the subsequent heat recovery sections is maintained at the same rate as the design for normal operation on air in the oxygen-enriched air case. Consequently, stack gas temperatures and flow rates are lower than in the case when high firing rates are applied.

The present invention avoids the problem associated with fuel system control limits, induced draft fan limits, and excess reformer tube wall temperatures. Changes in control systems, and induced draft fans require capital and time to implement. This invention also avoids high tube-wall temperatures with oxygen addition to the process gas because little additional heat from the furnace is needed to drive the reactions. The oxygen partial oxidation provides most of that heat. In oxygen-enriched combustion, most of the additional heat produced by combustion is available at the front end of the reformer where tube wall temperatures are low, due to the highly endothermic nature of the reforming reactions in that portion of the reformer.

Adding a low temperature shift unit is only an option in cases where one does not already exist. This concept does not actually increase the capacity of the reforming process. These units are difficult to operate and improve operations by increasing the conversion of reformer product to hydrogen. The low temperature shift option requires additional capital, is limited by the residual carbon dioxide content of the gas leaving the high temperature shift unit, and is of little or no value if the syngas produced by the reformer is used for producing chemicals such as methanol or ammonia. The proposed concepts increase the quantity of syngas from the reformer without the expenditure of significant capital. For a hydrogen plant, the quantity of syngas to the shift conversion section is increased. A low-temperature shift conversion unit could be added to further increase the hydrogen production.

A pre-reformer is capital intensive because it involves the addition of a catalytic reactor in addition to modifying the convective heat recovery section to provide the heat necessary for driving the reforming reactions. The large quantity of catalyst used in the pre-reformer is generally twice as expensive as that for the primary reformer and has a relatively short life. In addition, the quantity of steam available for export is reduced.

The present process does not require a separate reactor vessel or changes in the convective section of the reformer, thus reducing capital requirements. The net steam production is impacted less than in the pre-reformer case.

The bypass-feed product-heat-exchange reformer is capital intensive because it involves the addition of a catalytic reactor downstream of the primary reformer. Maintenance is difficult on this heat-exchanger reactor. In addition, export steam production is lost because the heat in the exhaust of the primary reformer is used to drive additional hydrocarbon conversion to carbon monoxide and hydrogen. This concept was developed to eliminate or reduce export steam production from the reformer. The proposed concepts are designed to maintain essentially equal export steam production to the unmodified primary reformer.

The oxygen secondary reformer is a refractory-lined reactor with a combustor located at the entrance to the catalyst bed. The secondary reformer is placed downstream of the primary reformer. Oxygen and steam are reacted with the primary reformer product to raise the temperature of the mixture up to about 2,200° F. Relatively large quantities of the oxygen and steam are required to accomplish this temperature rise (600° F. to 800° F.). In addition, significant changes to the carbon dioxide removal system may be required because of the higher levels of carbon dioxide produced to raise the inlet temperature to the reformer. The concepts proposed here use less oxygen, produce less carbon dioxide, and do not require a separate reactor vessel or other significant capital investments.

Baseline Steam Methane Reforming

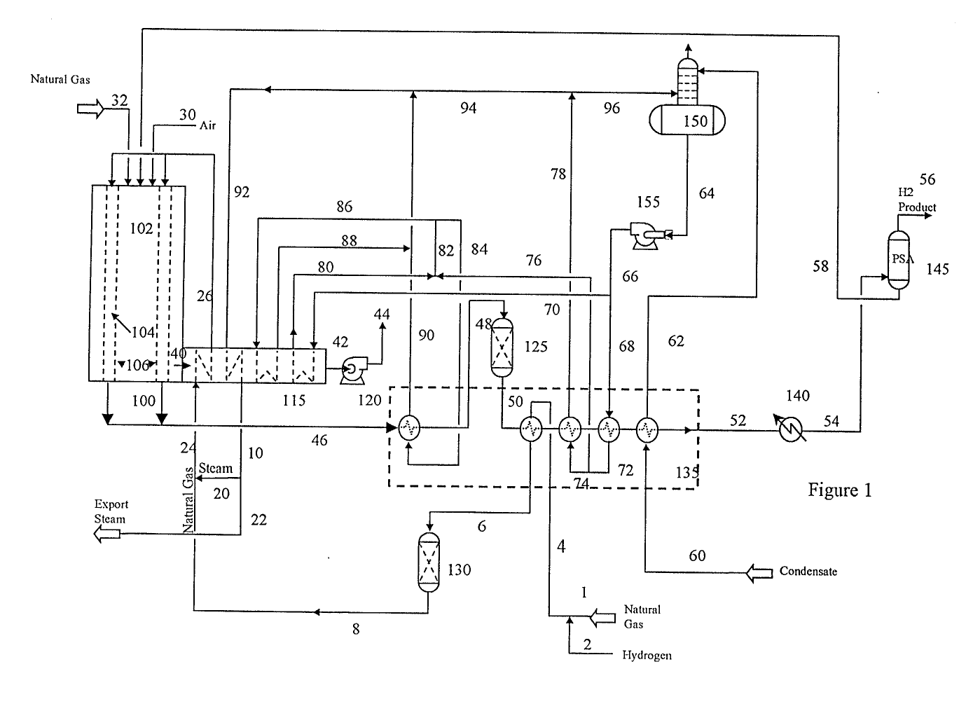

FIG. 1 shows the schematic diagram representative of a steam methane reformer system used for the production of hydrogen from natural gas. This is representative of a “high steam case.” This type of plant is designed for a relatively large quantity of steam for export. Other types of hydrogen plant designs are used. One designated “low steam” design preheats the air to the combustor using heat in the flue gas, thus reducing the heat available for steam generation. There are other hydrogen and syngas designs based on steam methane reforming. The one described below uses a baseline for analyzing the impact of oxygen enhanced reformer operations. A critical assumption in these analyses is that for existing reformer based systems all equipment sizes are fixed. Additional capital is needed to change/modify equipment.

In FIG. 1, natural gas 1 is mixed with a small amount of hydrogen product 2 to form stream 4 that is preheated in product heat recovery system 135. The heated stream 6 is hydrotreated and sulfur is removed in combined hydrotreater adsorber 130. The sulfur-free feed stream 8 is mixed with steam 20 superheated against flue gas 40 in heat recovery unit 115, also known as the reformer's convection section. The steam to carbon ratio in stream 24 can vary depending on the design but normally is about 3/1. The natural gas-steam mixture 24 is further heated against flue gas 40 prior to injection into the reformer tubes 106 contained in reformer 100. The internal volume of the reformer tubes 104 are filled with catalyst, usually composed of nickel compounds. The catalyst promotes the conversion of the natural gas-steam mixture to hydrogen and carbon monoxide. Gas temperatures in the reformer ranges from about 900° F. to about 1700° F. Gas temperatures within the tubes increase from the reformer inlet to the exit. The maximum gas temperature, normally about 1600° F. is at the reformer exit. Both the steam methane reforming reaction and the shift conversion reaction take place within tube volume 104. The reformed gas exits reformer 100 as stream 46. Stream 46 is cooled in process-gas heat-recovery system 135 against hot water producing steam. After steam is generated, the still hot syngas exits unit 135 as stream 48 and enters shift conversion unit 125 where the shift reaction is driven further to the right (i.e., production of hydrogen and carbon dioxide).

The shift conversion reaction is slightly exothermic and the unit(s) normally operates at temperatures ranging from about 400° F. to about 900° F. In this case, stream 50, leaving the shift conversion reactor at up to about 800° F., is reintroduced to unit 135 where it is cooled against the feed gas 4 and various streams containing water. Gas 52, exiting process heat recovery section 135, is further cooled in unit 140 either against cooling water or through the use of fin-fan type air coolers prior to being introduced as stream 54 into the PSA 145. Not shown are various knockout units used to separate condensed water vapor from the process gas stream. The PSA produces hydrogen 56 at purities ranging from about 99% to about 99.999% based on the system design. The PSA hydrogen recovery can range from about 75% to about 95%. The unrecovered hydrogen and any carbon monoxide, methane, water vapor, and nitrogen present in stream 54 are purged from the PSA unit as tail gas 58. The tail gas is normally sent back to the reformer to be used as fuel.

Additional natural gas 32 and, for hydrogen plants with PSA purification, PSA tail gas 58 are burned with air 30 in burners (not shown) to provide the heat to drive the reforming reactions. The burner exhausts into the “radiant” section of the reformer 102 where the heat generated through combustion is transferred by radiant and convective mechanisms to the surface of tubes 106. Heat from the tube surface is conducted to the interior of the tubes and transferred to the process gas through convection. The tube wall temperature is a critical parameter influencing the life of the tubes. Excess temperatures can dramatically reduce the time between tube replacements. The flue gas 40, leaving the radiant section at temperatures ranging from about 1600° F. to about 2000° F., enters the convection section 115 where the contained sensible heat is used to preheat the natural gas-steam mixture as well as produce and superheat steam. The flue gas leaving the convection section 42 enters an induced draft fan 120 which is used to maintain the radiant section of the reformer at a pressure slightly below atmospheric. Stream 44 is sent to a flue stack where it is vented to the atmosphere, normally at temperatures in excess of about 260° F.

Stream 60, a mixture of condensate and makeup boiler feedwater, is heated in unit 135 then de-aerated in unit 150. Steam 96 is commonly used as a purge gas in the de-aerator. The de-aerated boiler feed water is pumped in unit 155 to the pressure needed to provide superheated steam at sufficient pressure for mixing with natural gas to produce stream 24 and/or high enough to provide superheated steam for export. Stream 66 is split into streams 68 and 70. Stream 68 is sent to unit 135 for heating to near the boiling temperature. Stream 72 is then split into streams 74 and 76. Stream 74 is boiled in unit 135. Stream 70 passes to unit 115 for heating to near the boiling temperature. Stream 80 is mixed with stream 76 to form stream 82 and then is split into streams 84 and 86 that passes to units 135 and 115 to be vaporized. Saturated steam from unit 115 (or 88) and unit 135 (or 90) are mixed with stream 78 in saturated steam header 94. Most of the steam is sent as stream 92 to be superheated in unit 115. A small quantity 96 is sent to the deaerator 150. The superheated steam leaves unit 115 as stream 10 and is split into stream 20 for mixing with the natural gas feed to the reformer and into stream 22 which can be sold, used to produce electricity, or used to provide heat to unit operations associated with a refinery or chemical plant operations.

Oxygen Addition to the Reformer Process Gas for Output Enhancement

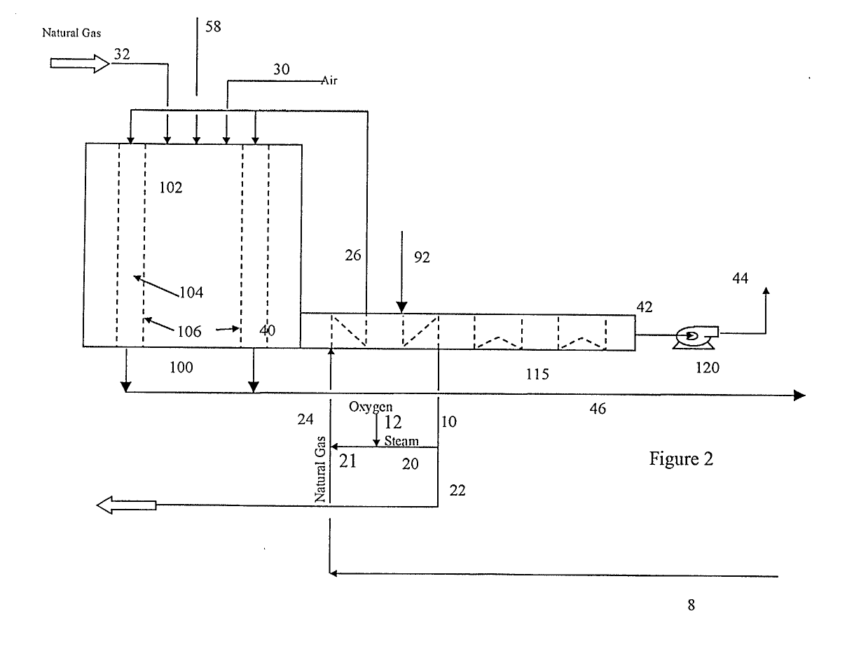

FIG. 2 is directed to the reformer section of the process shown in FIG. 1. This embodiment shows that increase in the output of the reformer without making changes in units 100, 115 and 120 and without dramatically reducing the steam production rate from the system. As provided herein, similar legends will have the same legend numbers in all of the figures. The critical difference between FIGS. 1 and 2 is the addition of oxygen to natural gas containing process gas. In the preferred embodiment, oxygen 12 that is normally at least 96% purity, and preferably greater than 99.5% purity is added to the steam 20 to form stream 21 that is then mixed with the hydrotreated and desulfurized natural gas 8 to form stream 24. The higher purity is required to minimize the argon and nitrogen contaminants in the product from the hydrogen plant. If the final reformer product is for syngas generation for ammonia or other chemicals or fuels, lower purity oxygen or even air may be used to enhance reformer output. Stream 24 is preheated in unit 115 and is transferred to the reformer tubes via stream 26. The oxygen added prior to introducing the process gas to the reformer results in additional syngas production because partial oxidation reactions will occur in the reactor in addition to the steam methane reforming and water-gas shift reactions. Since the partial oxidation reaction is exothermic:

CH₄+1/20₂←→2 H₂+CO

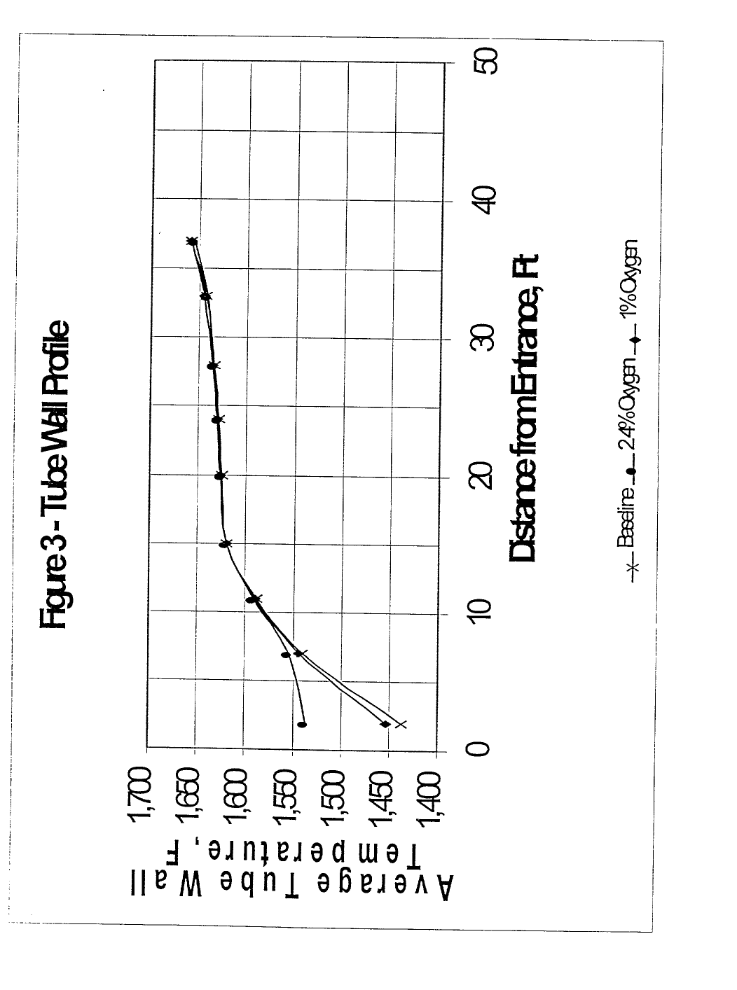

no additional heat is required from the combustion of fuel in the burners to provide the additional syngas (hydrogen plus carbon dioxide). Standard reforming catalyst can be used. However, if the retrofit of oxygen addition corresponds to a catalyst change-out then a layered catalyst using approach using a more effective partial oxidation catalyst followed by a more effective reforming catalyst could be employed. Since no additional heat transfer is required in the radiant zone of the reformer 102 to get additional output, the tube wall temperatures can be maintained near their original design as shown in FIG. 3. The higher temperature in the initial portion of the tube, near the inlet to the reformer, is a result of the partial oxidation reaction.

Table 1 shows the relative performance of the SMR consistent with the reformer temperature curve, shown in FIG. 3. The “oxygen %” is mole percent oxygen in the steam-natural gas-oxygen mixture 24. For 2.4% oxygen in the process gas stream, a 13% increase in reformer output is achieved with only a 9% increase in natural gas rate. In these analyses, the forced draft fan 120 is operated at the original design rate resulting in a constant flue-gas flow rate between the two cases. The fuel “firing” rate is held constant and the process gas flow is increased to ensure that the temperature of the flue gas leaving the reformer is equivalent in all cases. Under these conditions the amount of heat transferred in unit 100 and in unit 115 are the same in all cases.

The additional steam needed in stream 120 to maintain a constant steam to carbon ratio in stream 24 is obtained from the process heat recovery section 135 of FIG. 1. The water flow rates are adjusted to match the heat recoverable from the process gas stream before and after shift conversion unit 125 FIG. 1. The heat exchanger areas in both 115 and 135 do not require modification to provide the additional steam. Stream 52 is a little hotter in the cases with oxygen addition compared to the baseline reformer because more mass is being processed through heat exchangers of a constant surface area. The additional heat recovery is obtained by somewhat larger temperature differentials in the heat exchangers.

TABLE 1
Relative SMR Performance-Oxygen Added to
Process Gas

| | | 1% | 2.4% |
|---|---|---|---|
| | Baseline | Oxygen | Oxygen |
| Total Natural Gas Rate (Process plus | 1.00 | 1.04 | 1.09 |
| fuel) | | | |
| Process Gas-Inlet Temp, F | 1050 | 1024 | 989 |
| Process Gas-Steam/Carbon Ratio | 3.0 | 3.0 | 3.0 |
| Process Gas-Reformer Outlet | 1600 | 1600 | 1600 |
| Temp, F | | | |
| Process Gas-Heat Recovery Exit | 295 | 303 | 312 |
| Temp, F | | | |
| Fuel Gas Inlet Temp, F | 103 | 103 | 103 |
| Combustion Air temp, F | 90 | 90 | 90 |
| Relative Combustion Air Rate | 1.0 | 1.0 | 1.0 |
| Relative Firing Rate, Btu(lhv)/h | 1.0 | 1.0 | 1.0 |
| Radiant Zone Flue Gas Outlet, F | 1899 | 1903 | 1900 |
| ID Fan Inlet, T | 358 | 361 | 364 |
| Reformer Product Rate (H₂ plus CO) | 1.00 | 1.06 | 1.13 |

The maximum oxygen addition level that can be expected is about 5 mole %. Above that addition level, the ability to increase the productivity of the reformer will be limited by the pressure drop across in the reformer tubes. At 5 mole % oxygen in the steam-natural gas-oxygen mixture 24 would yield 25% to 30% increase in reformer capacity. If the oxygen addition concept is being implemented coincidentally with a tube change, it is possible to install larger tubes to accept the high flow rate associated with the 5 mole % oxygen mixture.

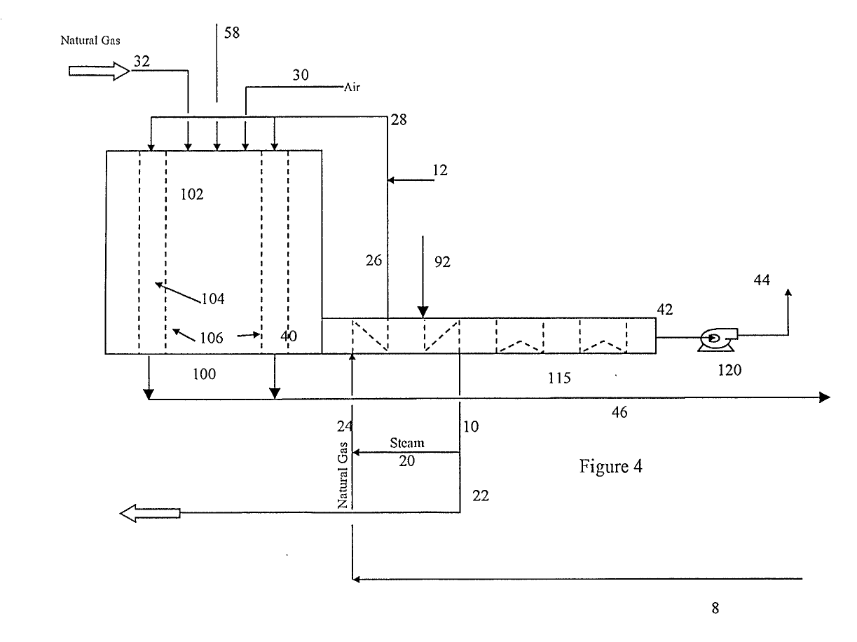

FIG. 4 shows an alternative configuration of oxygen addition to the reformer feed. In this case the oxygen is added to the heated steam-natural gas mixture just prior to introduction to the reformer tubes. Because oxygen 12 is delivered at a lower temperature (normally <300° F.) than steam-natural gas mixture 26 (normally >900° F.) a slight increase in the oxygen concentration is required to achieve the performance shown in Table 1.

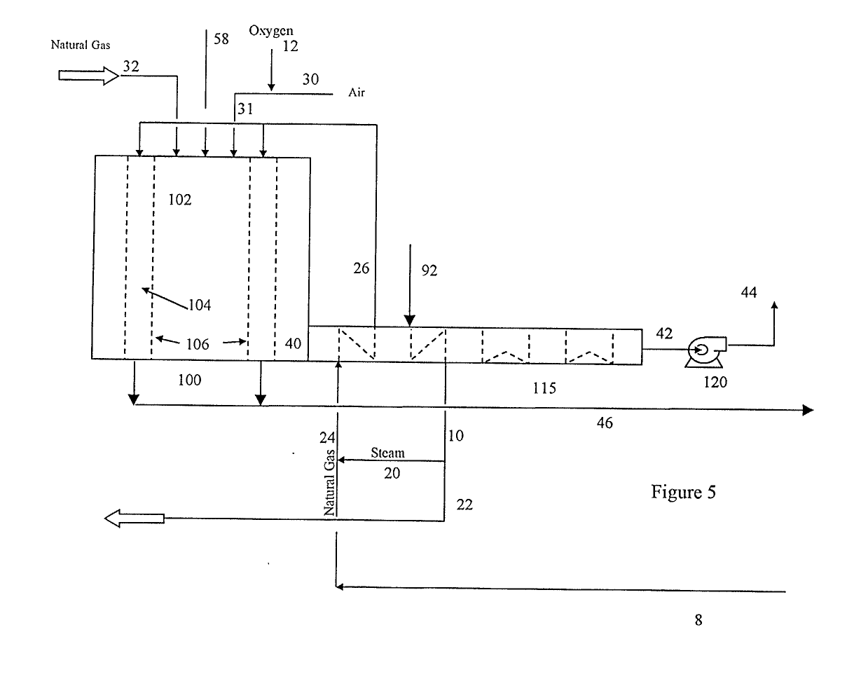

FIG. 5 presents the alternative approach to enhancing the throughput of existing steam methane reformers. The overall system is similar to the description provided for FIG. 1. In this embodiment the combustion air to SMR 30 is enriched using oxygen 12. The source of the oxygen can be liquid from a cryogenic plant, gaseous oxygen from an oxygen plant (PSA, cryogenic or membrane) or waste oxygen from a nitrogen plant (cryogenic or membrane). Induced draft fan 120 is maintained at the same rate as the baseline air system and all heat exchangers in unit 115 and 135 are unchanged. The reformer feed stream 26 flow is increased proportional to the oxygen enrichment rate to produce additional syngas and to maintain the tube wall temperatures within acceptable limits.

Table 2 summarizes the relative performance of the SMR as a function of the level of air enrichment. At the 21.7 mole % level it is highly likely that the 12% improvement in product rate can be achieved without problems with pressure drop in the reformer or other issues with downstream processing units. At 22.5 mole %, debottleknecking of the reformer tubes and other downstream processing equipment may be necessary. The maximum enrichment is limited to a level of about 25 mole % to 26 mole % oxygen in the combustion gas. Above that level, reformer tube pressure-drops will pose a major problem and significant amounts of capital will need to be invested for debottlenecking. Unlike the cases presented in Table 1, additional fuel firing is needed to obtain the projected output increases. The burner/fuel system modifications that may be needed by this approach makes the concept somewhat less attractive than the preferred case. In addition, the higher adiabatic flame temperatures may lead to a slight increase in NOx emissions when enriched combustion air is used.

TABLE 2
Relative SMR Performance-Air Enrichment

| | Baseline- | 21.7% | 22.5% |
|---|---|---|---|
| | 20.3% wet | wet | wet |
| Total Natural Gas Rate (Process | 1.00 | 1.08 | 1.13 |
| plus fuel) | | | |
| Process Gas-Inlet Temp, F | 1050 | 1019 | 986 |
| Process Gas-Steam/Carbon Ratio | 3.0 | 3.0 | 3.0 |
| Process Gas-Reformer Outlet | 1600 | 1590 | 1576 |
| Temp, F | | | |
| Process Gas-Heat Recovery Exit | 295 | 301 | 308 |
| Temp, F | | | |
| Fuel Gas Inlet Temp, F | 103 | 103 | 103 |
| Combustion Air temp, F | 90 | 90 | 90 |
| Relative Combustion Air/Enriched Air | 1.0 | 1.0 | 1.0 |
| Rate | | | |
| Relative Firing Rate, Btu(lhv)/h | 1.0 | 1.07 | 1.11 |
| Radiant Zone Flue Gas Outlet, F | 1899 | 1923 | 1930 |
| ID Fan Inlet, T | 358 | 365 | 368 |
| Reformer Product Rate (H₂ plus CO) | 1.00 | 1.12 | 1.17 |

The cases presented in Table 2 are derived from system with the same heat exchange surface areas in units 115 and 135. Because the temperature of stream 40 is higher in the enrichment cases more heat is recovered in unit 115. As in the preferred mode, most of the steam required to maintain the steam to carbon ratio in the reformer feed is obtained from heat recovery section 135 due to the high mass throughput in that section.

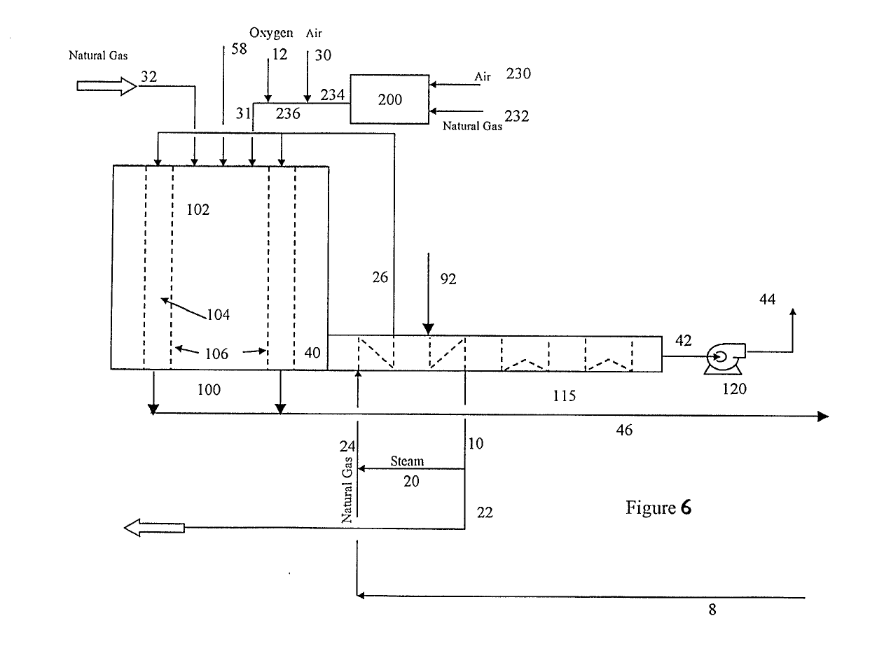

FIG. 6 shows the integration of a gas turbine 200 with an SMR 102. Air 230 and natural gas are fed to the gas turbine 200. The gas turbine produces electricity or drives a compressor and exhausts a hot gas 234 containing between about 10% and 18% oxygen. The hot gas can be mixed with additional air 30 to form stream 236. Stream 236 is further enriched with an oxygen stream containing more than 21% oxygen 12 to provide sufficient oxygen to burn the fuel 32 & 58 needed to drive the reformer at syngas production rate greater than that achievable with air alone. The relative flows of stream 10 and 12 are optimized based on the flow of gas from the gas turbine and the capacity of induced draft fan 120.

As an alternative to adding stream 12 to stream 36, higher purity oxygen—greater than about 96% oxygen by volume, could be added to the process gas as shown in FIG. 2.

Specific features of the invention are shown in one or more of the drawings for convenience only, as each feature may be combined with other features in accordance with the invention. Alternative embodiments will be recognized by those skilled in the art and are intended to be included within the scope of the claims.

What is claimed is:

1. A process for increasing the rate of syngas production by increasing the flow of a mixture of steam and methane into a steam methane reformer, said process comprises adding an oxygen-enriched gas to steam to produce an oxygen-enriched/steam mixture, then mixing methane with said oxygen-enriched/steam mixture and passing the resulting oxygen-enriched/steam/methane mixture into said reformer.

2. The process of claim 1 wherein said oxygen-enriched gas is a gas having at least 21% oxygen.

3. The process of claim 2 wherein said oxygen-enriched gas is pure oxygen.

4. The process of claim 1 which comprises using heat generated from the oxidation that results from the addition of oxygen-enriched/steam mixture to methane to drive the reforming reaction.

5. The process of claim 1 which comprises adding said oxygen-enriched gas to retrofit existing steam methane reformers.

6. The process of claim 1 wherein the reformer comprises combustion air that is partially provided by gas turbine exhaust.

7. A process for increasing the rate of syngas production by increasing the flow of a mixture of steam and methane into a steam methane reformer, said process comprises adding an oxygen-enriched gas to said mixture prior to passing the resulting oxygen-enriched/steam/methane mixture into said reformer.

8. The process of claim 7 wherein said oxygen-enriched gas is a gas having at least 21% oxygen.

9. The process of claim 8 wherein said oxygen-enriched gas is pure oxygen.

10. The process of claim 8 which comprises using heat generated from the oxidation resulting from the addition of oxygen-enriched gas to said steam/methane mixture to drive the reforming reaction.

11. The process of claim 7 which comprises adding said oxygen-enriched gas to retrofit existing steam methane reformers.

12. The process of claim 7 wherein the reformer comprises combustion air that is partially provided by gas turbine exhaust.

13. A process for increasing the rate of syngas production by increasing the flow of a mixture of steam and methane into a steam methane reformer, said process comprises adding an oxygen-enriched gas to combustion air to combust additional fuel to drive the reforming reaction.

14. The process of claim 13 wherein said oxygen-enriched gas is a gas having at least 21% oxygen.

15. The process of claim 14 wherein said oxygen-enriched gas is pure oxygen.

16. The process in claim 13 wherein the reformer comprises combustion air that is partially provided by gas turbine exhaust.

17. The process of claim 13 which comprises adding oxygen-enriched gas to retrofit existing steam methane reformers.
